(19) United States
(12) Patent Application Publication
(10) Pub. No.: US 2008/0236046 A1
(43) Pub. Date: Oct. 2, 2008

(54) Tamper Proof Locking Device for Window Balance Carriers

(75) Inventor: Jeffrey D. Tuller, Rochester, NY (US)

Correspondence Address: BROWN & MICHAELS, PC;400 M & T BANK BUILDING, 118 NORTH TIOGA ST, ITHACA, NY, 14850, US

(73) Assignee: CALDWELL MANUFACTURING COMPANY, INC., Rochester, NY (US)

(21) Appl. No.: 11/694,144

(22) Filed: Mar. 30, 2007

(51) Int. Cl. E05D 15/00

(52) U.S. Cl. 49/181

(57) ABSTRACT

A tamper proof interlock insert for window balance carriers that is non-permanently installed into a drop-in carrier to prevent the unauthorized removal of the sash from the window frame. The interlock insert is inserted into the channel by the window manufacturer after the pivot bar, which connects to the sash, has been inserted into the carrier. Once the interlock insert is installed in the carrier, the pivot bar cannot be removed. Since the interlock insert is non-permanently installed in the carrier it can be disengaged from the carrier relatively easily by a trained technician in the event that the sash must be removed from the window for repair or replacement.

### FIELD OF THE INVENTION

The invention pertains to the field of window balance carriers. More particularly, the invention pertains to a removable interlock insert to prevent the withdrawal of the sash pivot bar from the carrier and prohibit the removal of the sash from the jamb channel of the window frame.

### DESCRIPTION OF RELATED ART

Balance carriers are a common component of many windows. They are designed to travel in the jamb channel of a window frame and support the sash of the window by engaging a pivot bar located in each stile of the sash. The carrier is connected to a balance in the jamb channel which facilitates the vertical movement of the sash. Some window designs enable the sash to pivot so that both sides of the window pane can be easily cleaned from inside the home or building. With these designs, the carrier incorporates locking means which forcefully engages the walls of the jamb channel to temporarily secure the carrier in place and prevent it from further movement through the jamb channel during the process of pivoting the sash.

Numerous carriers are slotted so that the sash can be easily installed and removed. The sash is maneuvered so that the exposed end of the sash pivot bar easily slides into a slot in the carrier. These types of carriers are referred to as drop-in carriers. Window manufacturers often prefer these drop-in designs because they facilitate the assembly of the window. However, drop-in designs also permit the relatively easy removal of the sash once the window is installed in a home or other building. Depending on the requirements of the building design and the preferences of the building owner, this feature may be an undesirable feature of the drop-in carrier. In these instances, it is desirable to prevent the disengagement of the sash pivot bar from the carrier and the relatively easy removal of the sash from the window frame.

### SUMMARY OF THE INVENTION

The present invention is a tamper proof interlock insert for window balance carriers. It is installed into a vertical channel in the front surface of a drop-in carrier to prevent the unauthorized removal of the sash from the window frame. The channel of the drop-in carrier lockingly receives the interlock insert. The interlock insert may be inserted into the channel by the window manufacturer after the pivot bar, which connects to the sash, has been inserted into the carrier. Once the interlock insert is installed in the carrier, the pivot bar cannot be removed.

The interlock insert is non-permanently installed in the carrier. It can be disengaged from the carrier relatively easily by a trained technician in the event that the sash must be removed from the window for repair or replacement. However, the interlock insert prevents the unauthorized entry into a building by removal of the sash by an intruder from outside of the building or tampering by an inquisitive child of a window located on, for example, the upper floors of a building, which could result in serious injury or loss of life.

### BRIEF DESCRIPTION OF THE DRAWINGS

FIG. 1A shows a perspective view of the interlock insert of the invention.

FIG. 1B shows a perspective view of a carrier inside the jamb channel of a window.

FIG. 2 shows the interlock insert oriented for insertion into the carrier.

FIG. 3 shows the interlock insert installed in the carrier.

FIG. 4A shows a plan view of the combined carrier and interlock insert.

FIG. 4B shows a cross section view of the combined carrier and interlock insert along line B-B of FIG. 4A.

FIG. 4C shows a plan view of the interlock insert.

FIG. 4D shows a side view of the interlock insert.

FIG. 4E shows a perspective view of the front face of the carrier.

FIG. 4F shows a perspective view of the rear face of the carrier.

FIG. 5A shows a perspective view of a conventional sash pivot bar.

FIG. 5B shows a perspective view of the pivot bar installed in the carrier without the interlock insert.

FIG. 5C shows a perspective view of the combined carrier, pivot bar and interlock insert.

FIG. 6A shows a perspective view of a conventional friction adjuster.

FIG. 6B shows a perspective view of the carrier with the friction adjuster installed and the interlock insert oriented for insertion into the carrier.

FIG. 6C shows a perspective view of the carrier having a friction adjuster covered by the interlock insert installed within the carrier.

### DETAILED DESCRIPTION OF THE INVENTION

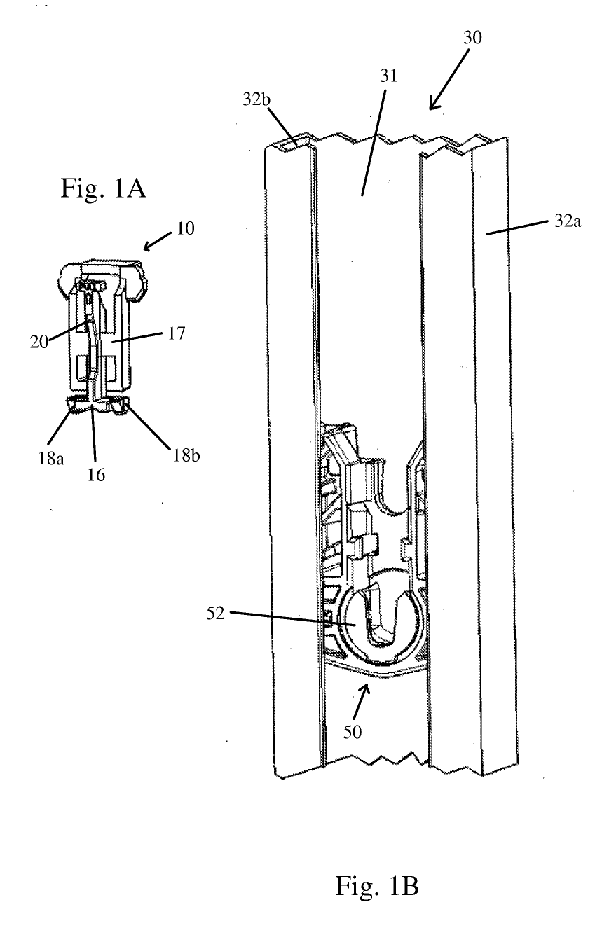

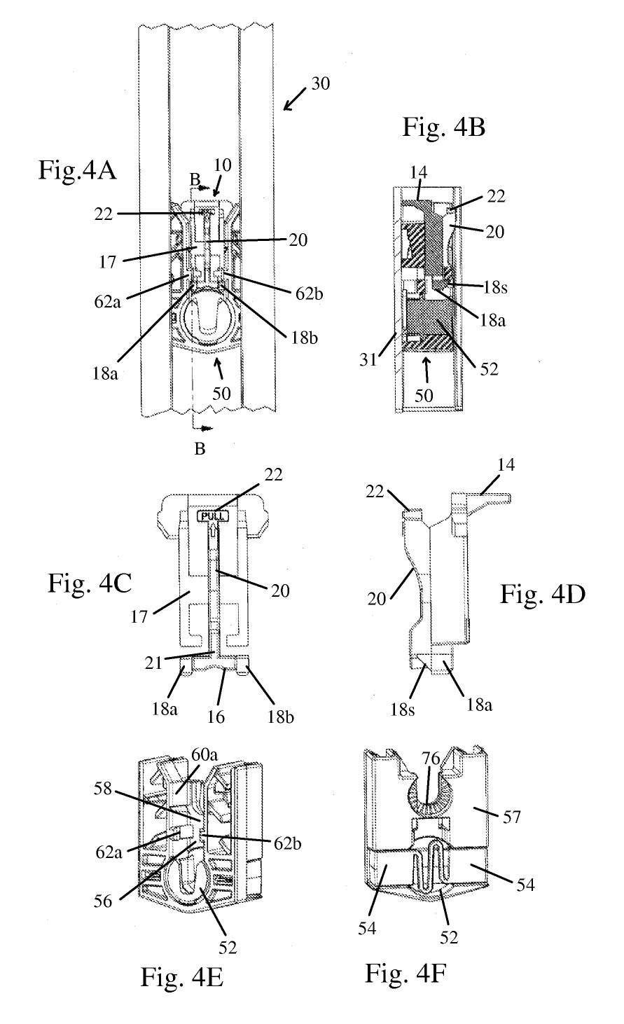

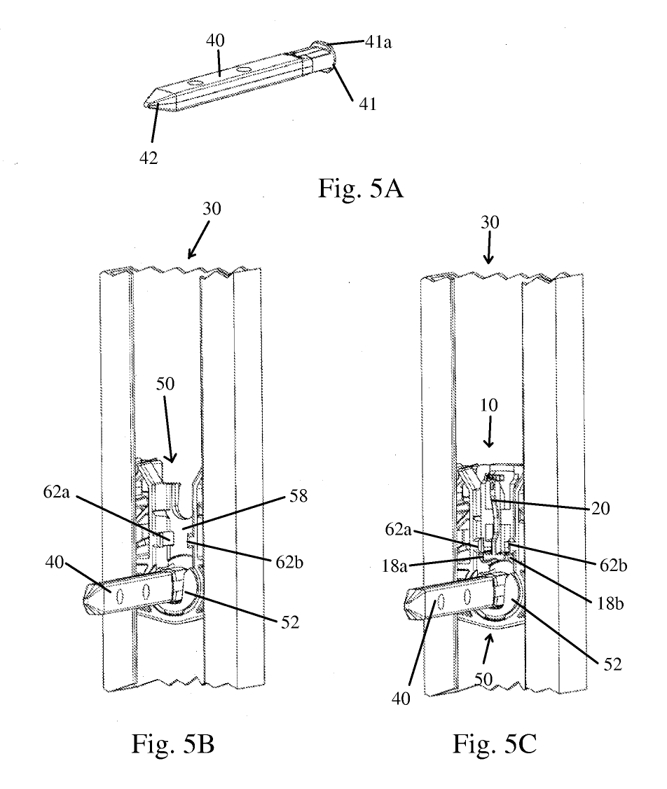

Referring to FIG. 1A, an interlock insert 10 of the present invention is shown. It is designed to be used in conjunction with and securely but non-permanently engage a carrier 50 located within the jamb channel 30 of a window frame. Jamb channel 30 consists of back wall 31 and opposing side walls 32a and 32b. The carrier 50 includes a cam 52 for receiving a first end 41 of a pivot bar 40 (see FIGS. 5A and 5B). The first end 41 contains an integral head portion 41a that allows its retention once it is inserted into the slotted opening of cam 52. A second end 42 of the pivot bar 40 is connected to a sash (not shown). The carrier 50 moves through the jamb channel 30 to facilitate the vertical movement of the sash. When it is desired to clean the window, the sash is pivoted about the pivot bar 40. As the pivot bar 40 rotates, the cam 52 in turn, also rotates which causes locking shoes 54 (see FIG. 4F) to forcefully engage the interior surfaces of side walls 32a and 32b of the jamb channel 30 to secure the carrier in position so that the sash can be tilted without vertical slippage of the sash along the jamb channel 30.

The interlock insert 10 includes a vertical manipulation spine 20 (see FIG. 4D), a locking arm 16 and middle support strut 17 (see FIG. 4C). Locking arm 16 contains enlarged end portions 18a and 18b and is perpendicular to and integrally formed with the lower end 21 of the elongated vertical manipulation spine 20. Each enlarged end portion 18a and 18b contains a sloped surface 18s (best shown in FIG. 4D). At the upper end of manipulation spine 20 is manipulation tab 22.

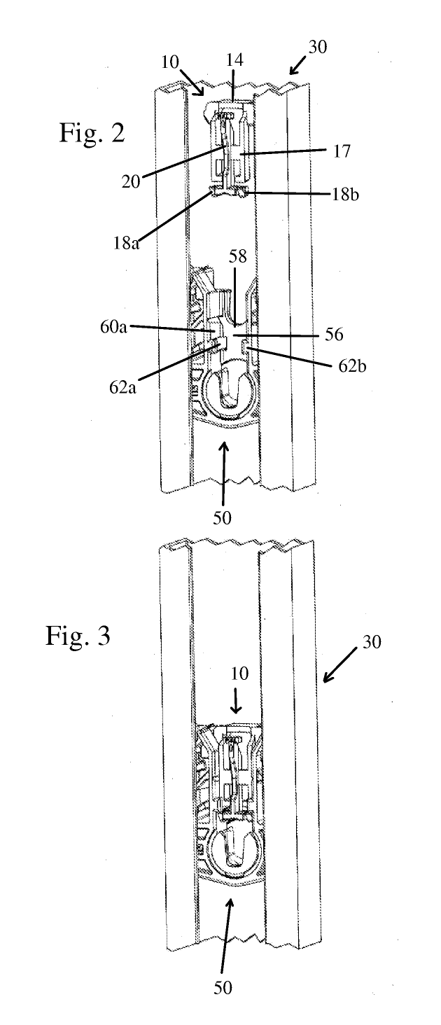

Carrier 50 contains a channel 56 for receiving the interlock insert 10. Channel 56 contains a rear wall 58 and opposing side walls 60a and 60b. Each side wall 60a and 60b contains an integrally formed locking tab 62a and 62b, respectively (see FIG. 4E). Referring to FIGS. 2 and 3, the interlock insert 10 is oriented above the carrier 50, ready to be inserted into the channel 56 of the carrier. A substantially horizontal flat ledge 14 is located at the upper end of the interlock insert 10. As a downward manual force is applied to ledge 14, the sloped surfaces 18s of the enlarged end portions 18a and 18b contact locking tabs 62a and 62b, respectively. As force is increased, the middle support strut 17 flexes sufficiently enough to begin deflecting the enlarged end portions 18a and 18b of locking arm 16 and urge them around locking tabs 62a and 62b. This results in the locking engagement of the enlarged end portions 18a and 18b with respective locking tabs 62a and 62b. With the interlock insert 10 now securely engaged with the carrier 50, the pivot bar 40 cannot be removed from the cam 52 (see FIG. 5C), which in turn, prevents the removal of the sash by prohibiting tampering of the carrier and the pivot bar 40. Thus, the interlock insert 10 is referred to as a “tamper lock” within the context of drop-in window balance carriers.

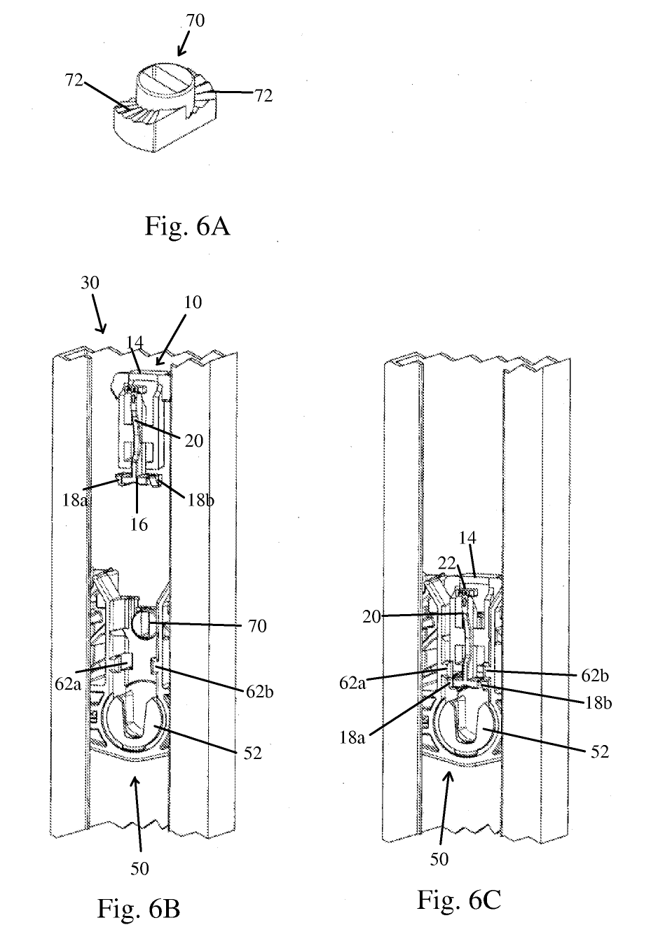

The carrier 50 may optionally be assembled with a friction adjuster 70, as shown in FIG. 6A. The friction adjuster 70 is seated in the rear wall 58 of the carrier 50 and is rotatably movable to adjust the amount of friction between the carrier 50 and the jamb channel 30. Opposing graduated stepped teeth 72 on the friction adjuster 70 engage with corresponding mating graduated stepped teeth 76 within a cut out in the back surface 57 of the rear wall 58 of carrier 50 (see FIG. 4F). Window manufacturers often prefer to apply a pre-set amount of friction to regulate the force required to move the carrier 50 through the jamb channel 30. This is done by turning friction adjuster 70 using a conventional tool, such as a screw driver. The rotation of the friction adjuster 70 results in its being urged outward from the carrier 50 against the back wall 31 of the jamb channel 30. The more the friction adjuster 70 is rotated, the more frictional force is created between the carrier 50 and the jamb channel 30. Once the desired amount of friction is set, either by the window manufacturer at the time of window assembly or by the window installer at the time the window is installed in a building, the friction cannot be altered by tampering from the homeowner or building maintenance personnel because of the presence of the interlock insert 10 in the carrier 50.

As noted previously, a desired feature of the interlock insert 10 of the present invention is the ability to readily remove it from the carrier 50 should the need arise to remove the sash for the purpose of repair or replacement of one or more elements of the window assembly. This would preferably be performed by an experienced technician. The method of removing the interlock insert 10 from the carrier 50 consists of the steps of (a) having a trained technician place an index finger behind the manipulation tab 22, (b) while placing the thumb from the same hand against the front surface of manipulation spine 20, (c) pulling the manipulation tab 22 outward, and (d) lifting the interlock insert 10 vertically upward through the channel 56 of carrier 50 until the interlock insert 10 is completely separated from the carrier 50. The action of pulling on the manipulation tab 22 while applying pressure against the front of the manipulation spine 20 causes the middle support strut 17 to flex in such a way that the enlarged end portions 18a and 18b of locking arm 16 are urged to disengage with their respective locking tabs 62a and 62b. This “unlocks” the interlock insert 10 to permit the separation of the interlock insert 10 from the carrier 50.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A locking device for window balance carriers comprising:
a) a carrier slidably contained within a jamb channel of a window frame, the carrier having a vertical channel; and
b) an interlock insert for non-permanent locking engagement within the channel of the carrier.

2. The locking device of claim 1 wherein the channel has a rear wall and opposing side walls; each side wall having an integrally formed locking tab.

3. The locking device of claim 1 wherein the interlock insert has an upper region containing a ledge and a flexible middle support strut.

4. The locking device of claim 3 wherein the interlock insert contains a manipulation element integrally connected to the flexible middle support strut.

5. The locking device of claim 4 wherein the manipulation element contains a vertical manipulation spine having an upper end and a lower end; wherein the upper end contains a manipulation tab and the lower end contains an integrally connected perpendicularly disposed locking arm; each end of the locking arm having an enlarged end portions; and each end portion having a sloped surface.

6. The locking device of claim 5 wherein each of the enlarged end portions of the locking arm securely engages each of the locking tabs in the channel of the carrier.

7. The locking device of claim 1 wherein the carrier includes a rotatable cam for receiving a sash pivot bar of a window sash.

8. A method for installing an interlock insert into a window balance carrier; the interlock insert having an upper region containing a ledge, a flexible middle support strut, a vertical manipulation having an upper end and a lower end, the upper end of the manipulation spine having a manipulation tab and the lower end of the manipulation spine having a locking arm perpendicular to the axis of the manipulation spine, with the locking arm terminating in enlarged end portions, and each end portion having a sloped surface; the carrier having a vertical channel having an open upper end and a closed lower end, a rear wall and opposing side walls, with each side wall having an integrally formed locking tab; the method comprising the steps of:
a) aligning locking arm of the interlock insert with the open upper end of the vertical channel of the carrier; and
b) applying a force to the ledge to urge the interlock insert into the vertical channel until each of the enlarged end portions of the locking arm lockingly engages a corresponding locking tab on each side wall of the vertical channel.

9. A method for removing the interlock insert of claim 8 from a window carrier balance comprising the steps of:
(a) having a trained technician place a finger behind the manipulation tab;
(b) placing the thumb from the same hand of the technician against the front surface of manipulation spine;
(c) pulling the manipulation tab outward; and
(d) lifting the interlock insert vertically upward through the channel of the carrier until the interlock insert is completely separated from the carrier.
